(19) United States
(12) Patent Application Publication
(10) Pub. No.: US 2013/0211717 A1
(43) Pub. Date: Aug. 15, 2013

(54) UNIVERSAL REMOTE TERMINAL UNIT FOR TRACKING THE STATUS AND POSITION OF SELF-PROPELLED IRRIGATION SYSTEMS

(71) Applicant: Karlyle Haaland, (US)

(72) Inventor: Gerald L. Abts, Denver, CO (US)

(73) Assignee: Karlyle Haaland, Dalhart, TX (US)

(21) Appl. No.: 13/633,264

(22) Filed: Oct. 2, 2012

Related U.S. Application Data
(60) Provisional application No. 61/597,567, filed on Feb. 10, 2012.

(51) Int. Cl. B05B 12/00

(52) U.S. Cl. 701/485

(57) ABSTRACT

A universal remote monitoring system for irrigation systems having a self-contained remote terminal unit mounted at an outer portion of the irrigation system that is independent of the irrigation system's electrical control and power circuitry. The unit includes a programmable, three-axis accelerometer to detect lateral movement of the pivot arm in either direction. The unit can also include a global positioning system for producing coordinate data, a computer for processing the accelerometer movement data and GPS coordinate data into operational data, and a transmitter for delivering the operational data to a communications satellite or terrestrial communications tower. The satellite or terrestrial communications tower relays the operational data through a communications network into a remote internet-connected service computer that generates information messages to mobile operator devices informing the operator of movement status, water delivery status, position status and other operational information.

### RELATED APPLICATION

The present application is based on and claims priority to the Applicant's U.S. Provisional Patent Application 61/597,567, entitled “Universal Remote Terminal Unit For Tracking The Status And Position Of Self-Propelled Irrigation Systems,” filed on Feb. 10, 2012.

### BACKGROUND OF THE INVENTION

1. Field of the Invention

The present invention relates generally to self-propelled center pivot and lateral move irrigation systems. More specifically, the present invention relates to a remote monitoring unit which senses movement or non-movement of the irrigation system over a span of time to determine operating status (running or stopped), to determine pivot arm position (e.g., location of last wheel set), to determine the direction of the pivot movement (clockwise or counter-clockwise) and to remotely sense water delivery through the span pipes to determine wet/dry status. The remote monitoring unit is self-contained without having to hard-wire directly to any existing control or other electrical circuits of the irrigation system.

2. Statement of the Problem

Mechanized sprinkler irrigation systems, such as center pivot and lateral move irrigation systems, are commonly used and over 200,000 exist in the United States alone. Typical systems irrigate over 100 acres to as high as 600 acres. Factors such as soil type, soil water intake rate, slope, water availability, energy costs, flotation for wheels and land obstacles affect the use of such systems. Large farms with scattered field sites and multiple crops are typical users of center pivot and lateral or linear move mechanized irrigation systems. Manually monitoring such systems by on-site inspections has been the norm. Two to three daily on-site visits by 4 WD pickup truck, SUV or ATV are considered minimal to observe and respond to shutdowns and breakdowns and to maintain irrigation schedules that meet crop-watering requirements. An unnoticed shutdown may result in substantial loss of the crop.

Center pivot irrigation systems typically are set up to apply a specific amount of water to the whole field (one 360 degree rotation). Such applications typically take three to four days to complete and longer for larger fields. Therefore, the amount of changes to the pivot setup is infrequent (one or two per week, driven by weather and crop growth stage). In terms of remote control and monitoring, the primary need is to know the status (i.e., is the irrigation system running (moving), with or without water or has it shut down?) Unplanned stoppages are common due to field conditions (stuck drive wheels) and mechanical and electrical malfunctions (broken drive lines, failed electro-mechanical devices, etc.). Water delivery systems also breakdown and cause irrigation systems to stop. Electrical power outages and deliberate load shed schemes by power providers can cause hundreds of irrigation systems to shutdown at any hour of the day. Water delivery systems powered by natural gas engines are subject to gas line pressure fluctuations that can cause internal combustion engines to shutdown, resulting in loss of water delivery and a center pivot shutdown. Mechanized irrigation systems need to be monitored 24/7 to maintain critical watering schedules for optimum yield and crop quality.

Over the last thirty years, several remote monitoring systems have been put to commercial use. All use telemetry and all require a wired interface between: (a) the control circuitry of the center pivot main panel or span mounted electrical enclosures containing circuitry for controlling individual tower movement; and (b) the digital and analog inputs to the monitoring device, typically called a remote terminal unit (RTU). Typical RTUs include either a hard wire connection to telephone circuits or a wireless radio for remote communication. Telemetry systems sold by irrigation system manufacturers often include electronic and programmable center pivot main panels (or other hardware retrofits) at the center pivot point with radio telemetry paths to on-farm base-station computers, running proprietary software. Most include remote control functions and some monitor pivot position using an electronic encoder or resolver, rotated at the pivot center point by the movement of the first drive tower, to sense pivot arm position in degrees from north at the front of the center pivot. The pivot arm position, in turn, is used by a programmed set of instructions stored in the pivot main panel or at a base station computer to initiate control changes based on pivot arm position such as pivot speed changes, pivot direction changes, turning the pivot off, end guns on, etc.

More recent developments by center pivot manufacturers and others have been to use an end-of-system GPS receiver in lieu of the mechanical encoder or resolver heretofore used with the programmable main panels to determine pivot arm position (azimuth from the center pivot point or a starting point for a lateral move sprinkler) and, thereby, control the functions of a center sprinkler based on pivot arm position in degrees (azimuth) or control the functions of a lateral move sprinkler based on feet of linear movement of a drive tower from a starting point in the field.

U.S. Pat. No. 6,512,992 (Fowler et al.,) refers to a GPS-based control system for irrigation using two GPS receivers. This system claims an improved positioning and alignment system by using GPS and differential GPS (DGPS) methods to monitor the absolute and/or relative position of a selected location near the end of the pivot arm referenced from a fixed, known position of a central tower (center pivot point). Fowler describes a device to determine pivot arm position (azimuth and the distance between the fixed center point and the end of the moving pivot arm) using two GPS receivers, one at the fixed center pivot point and a second at the end of the moving pivot arm. The two GPS receivers (one or both with differential GPS) communicate with each other to remove GPS errors. Fowler also claims a device to detect the degree of misalignment of drive towers along the pivot arm using the two GPS receivers. Fowler further claims a method of controlling the plurality of reversible drive motors (one at each drive tower) to maintain alignment of the jointed pipe spans making up the length of the pivot arm. Fowler also claims a method of monitoring the degree of misalignment in order to identify failed drive towers.

U.S. Patent Application Pub. No. 2004/0117070 (Barker) refers to a GPS-based control system for irrigation that uses a single GPS receiver at the end of the pivot arm. This GPS receiver has stored in memory the coordinates for the fixed GPS position of the center pivot point. Using the stored reference GPS coordinates of the center point along with the roving GPS receiver's coordinates facilitates calculation of the pivot arm azimuth with a single GPS receiver. Barker asserts that there is a need for an improved control system for center pivot and lateral move sprinklers that uses GPS to accurately detect the angular position of a center pivot arm and to accurately detect the distance traveled by a lateral move sprinkler, and that uses such information to control various functions of the irrigation system. The control system receives the two GPS position coordinates (one fixed and stored, the other from the roving GPS receiver at the end of the pivot arm) and communicates with the center pivot main panel to control a function of the irrigation system, such as stopping, reversing, end gun operation, application rate, etc., at a selected distance (lateral move sprinkler) or azimuth value (center pivot).

Without regard to the type of main panel or the degree of programmability based on pivot arm position, the prior art method of remotely monitoring on/off status is to monitor the electric control circuitry with digital inputs interfaced and hard wired from a remote terminal unit (RTU) to the electrical circuitry of the center pivot control panel located at the fixed center pivot point or to an electrical enclosure located at an outer tower (tower box). This requires electrical connections either inside the center pivot main panel or inside a tower box enclosure located at an outer span support tower. Because there are many brands and models of center pivots in use, many with unique control circuitry, a degree of expertise and electrical wiring competency is required for safe and correct installation that provides the needed functionality and meets the requirements of the National Electrical Code for Center Pivot and Lateral Move Sprinklers. Furthermore, the sensitive electronics and radios needed to remotely monitor pivot status by this hard-wired method are easily interfered with and can be damaged from improper installation, electrical power surges and lightning events. As a result, such systems tend to be costly to manufacturer, install and maintain.

These types of remote monitoring and control systems are expensive and are often impractical on older pivots without extensive upgrades to the pivot point and the pivot controls. Often older pivot control circuitry has been field modified over years of maintenance. Many lack proper documentation to facilitate the proper interface of circuitry wires required with traditional remote monitoring devices. As a result, many irrigation equipment and repair service providers (e.g., center pivot dealers) avoid selling and promoting the typical hard-wired remote monitoring devices.

A need therefore exists for a universal remote terminal unit (RTU) that does not interface with the AC control or AC power wiring of the mechanized irrigation system. A need further exists to provide a self-contained RTU that simply mechanically mounts to an outer span tower and has no wires or electrical devices to connect to the pivot circuitry. A need further exists to self-contain the RTU with independent power, and with the ability to independently detect movement and non-movement and water delivery status, and to transmit such status changes to a remote location in a format that is easily understood by the operator of the mechanized irrigation systems. A need further exists for a universal RTU that is simple to install, without electrical wiring know-how and is simple to relocate to alternative center pivots for maximum utility and cost effectiveness. A need further exists for a wireless device for determining pivot position (azimuth of the pivot arm around the center point or the linear location of a lateral move sprinkler) using a single GPS receiver at or near the end of the pivot arm.

The present invention improves on the inventor's prior patent (U.S. Pat. No. 7,584,053 (Abts)) that generally addressed the same need. Specifically, the prior patent describes a wireless system for monitoring center pivot movement through the use of a current sensor. The current sensor, while theoretically adequate, proved problematic in application. The thousand plus feet of steel structure combined with the electrical power and control circuits and three-phase AC motors caused occasional electrical interference with the intended function of the current sensor. Therefore, in application, the current sensor was lacking in reliability, resulting in false positives that limited the usefulness of the concept.

3. Solution to the Problem

In response to the shortcomings of prior art system discussed above, the present invention employs an accelerometer in place of a current sensor to wirelessly determine pivot movement or non-movement. The small accelerometer can be mounted to the remote terminal unit (RTU) motherboard. Thus, the accelerometer can eliminate the need to place a sensor device outside of the self-contained RTU enclosure.

### SUMMARY OF THE INVENTION

The present invention is directed to a self-contained, universal RTU that mounts at an outer tower of a center pivot or lateral move sprinkler and communicates data packets concerning the pivot status to a central server by terrestrial or satellite communication networks. Changes in monitored status of the sprinkler system are conventionally transmitted to a central server and recorded in a central server data base which is used to update website pages that display pivot status and history. Irrigators are in turn alerted to changed pivot status using voice telephone messages, e-mail messages, text messaging to cell phones, PDAs, iPads, pagers and other portable internet-connected devices. See U.S. Pat. No. 6,337,971 that is incorporated herein by reference. The term “universal RTU” is used in this application to designate an RTU that can be used with all past and future mechanized center pivot and lateral move irrigation systems.

An accelerometer is used by the present invention to detect movement of an outer drive tower and thereby pivot running status (on or off). The accelerometer device is standard and readily available. The accelerometer need only be mounted inside the universal RTU that is in turn attached (mounted) to an outer drive tower of the pivot. Preferably, a three-axis accelerometer is employed, which eliminates the need to maintain a vertical or horizontal position of the accelerometer device relative to the direction of gravity. The present invention completely eliminates the need for any hard-wire connections between the circuitry of a remote terminal unit (RTU) and the AC control or power circuits of the center pivot irrigation system in order to establish pivot on/off status. Use of an accelerometer along with specific processor logic enables the universal RTU of the present invention to determine if a center pivot sprinkler is running (moving) or stopped. The use of an accelerometer by the system eliminates any need for a hard-wired interface with the existing control or power circuits (i.e., the present invention comprises a truly wireless interface remote monitoring system). The accelerometer need only be mounted on the inside of the RTU enclosure that is mechanically attached to an outer pivot tower that moves.

In addition to an accelerometer, a GPS (Global Positioning Satellite) receiver can also be built into the RTU. The GPS data can be used either as a supplement to the accelerometer data, or as a redundant system for monitoring movement. Installation of a remote monitoring device (RTU) is thereby greatly simplified, requiring no hard-wire electrical connections or electrical wiring skills. This saves on installation and hardware costs, simplifies portability of RTUs among alternative center pivots, and greatly improves reliability by isolating the RTU electronics from the high-voltage circuits traditionally used to monitor pivot-running status.

The GPS receiver is simple in application, requiring no wired connections to the center pivot control or power circuitry. GPS coordinate data for the location (position) of the RTU, which is mounted to a roving (moving) outer tower of the pivot, is used by the on-board processor to calculate the azimuth of the pivot arm from the fixed center point of the circle. The coordinates of the fixed center point of the circle can be determined by storing a series of sets of GPS coordinate data over time that correspond to a plurality of locations along the perimeter of the circle traversed by the moving RTU. The fixed center point is defined by determining the point at which two radial lines intersect. Once determined, the center point coordinates can be stored in the memory of the RTU processor and are then available for future use in dynamic calculations of the pivot arm position and azimuth.

Another means for determining the center point of the pivot circle would be to transmit the GPS coordinate data for the points along the circumference of the circle to the central control computer by conventional telemetry. The central control computer can determine the center point of the pivot from a database of these GPS coordinates. In turn, using the fixed center point coordinates in combination with the current GPS receiver coordinates reported by the RTU to the central server, the central server software can calculate the azimuth of the RTU relative to the center point of the pivot (i.e., the pivot arm position). This data is readily graphed to internet websites or other graphic displays using a circle (or partial circle) with a single spoke indicating the location of the center pivot arm. The GPS data can also be used to determine the direction of travel of the pivot arm (forward or reverse) and the speed of travel and, thereby, the rate of water application. See U.S. Pat. No. 7,584,053 that is incorporated herein by reference.

Another means for determining the center point of the pivot would be to pre-program or transmit this data to the RTU. These coordinates can be obtained using Google mapping software or other similar software readily available via the internet that displays satellite or aerial photo images of the green watering pattern created by a particular pivot. Once stored in the memory of the RTU, the center point coordinates are available to be used in dynamic calculations in determining the azimuth or position of the roving span about the center point.

The wireless interface, universal RTU of the present invention in one embodiment is mounted on top of the span pipe on the last or next-to-last drive-tower of the center pivot (i.e., the best locations to sense pivot movement and suitable locations to sense water pressure or flow and pivot arm position using GPS coordinate data, and to provide optimum data transfer telemetry). Monitoring pivot movement or non-movement with a simple accelerometer does not require a hard-wire interface to the pivot control or power circuitry. Likewise, the incorporation of a GPS receiver in the RTU does not require a hard-wire interface to the pivot control or power circuitry, and the GPS receiver enables a redundant means to the accelerometer of sensing movement or non-movement of an outer span of the center pivot arm over time.

The present invention will work equally well on any electrically powered center pivot or lateral move sprinkler with electrical circuits controlling and powering the movement of the outer spans.

The RTU of the present invention is self-contained. The low power RTU with telemetry radio, accelerometer and GPS receiver is powered by a battery with a solar panel for recharge either incorporated into the RTU or with separately mounted solar array. With the RTU mounted on top of the center pivot span pipe, generally twelve to fifteen feet above ground level and above the water spray and the crop canopy, the problem of mineral deposits forming on the surface of the solar panels is greatly mitigated and any shadow effects from the pivot structure or the crop on the solar panel are also eliminated.

With scarce and expensive labor and high vehicle operating costs, the self-contained RTU of the present invention offers the operators of mechanized irrigation systems a low cost method of: (1) Remotely monitoring the movement or non-movement of a center pivot to determine if it is running, with or without water delivery; (2) Tracking pivot arm movement over time and to determine current pivot arm position (the azimuth relative to the fixed pivot point), speed of rotation, direction of travel of the pivot arm, and rate of water application—all from the GPS coordinate data transmitted from the RTU mounted to the moving pivot arm; and (3) Using a central server with internet connectivity and wireless telemetry to provide a method of alerting operators to status changes in a timely manner, wherever they are.

In particular the use of the wireless interface remote monitoring device to determine pivot movement or non-movement is a practical way to monitor running or stopped status of any electric center pivot or linear move irrigation system.

It is an object of the present invention to provide a safe and simplified installation, requiring no electrical circuitry know-how, and an improved method to remotely monitor center pivot running status (on or off, wet or dry, and pivot arm position, direction, speed of travel and rate of water application) with improved reliability and lowered cost.

It is a further object of the present invention to provide a safe, wireless and simplified installation of a self-contained RTU with a self-contained accelerometer to detect movement over time, and a water delivery pressure switch, transducer or other sensor to detect water delivery, to remotely monitor center pivot status with improved reliability and lowered cost.

It is a still further object of the present invention to remotely sense pivot movement or non-movement by means of an accelerometer incorporated into the self-contained RTU that rapidly detects the movement or non-movement of the center pivot and to send such moving or non-moving status data by means of long distance telemetry to a central control computer operated by a third party service operator for the benefit of pivot operators anywhere.

It is a further object of the present invention to redundantly sense pivot movement or non-movement by means of a GPS receiver incorporated into the RTU. The RTU processor determines movement or non-movement based on changing or static GPS coordinate readings taken over a longer span of time (than is required by an accelerometer) and within the error tolerance of the GPS method. Based on GPS coordinate readings, the processor determines a change in status from movement to non-movement or non-movement to movement. Once determined, the change in status can be treated as an event by the RTU. Each event so determined can cause the RTU to transmit a data packet including GPS coordinate data by means of long distance telemetry to a central control computer operated by a service operator for the benefit of pivot operators anywhere. Data transmitted will include: (1) GPS coordinate readings over time to enable a central computer to double check the RTU calculations made using accelerometer movement data that resulted in an event that triggered the data packet transmission from the RTU to the central server; (2) GPS coordinate readings over time to enable a central computer to calculate the fixed center point of the center pivot arc created by the movement of the roving pivot arm; (3) GPS coordinate readings over time to enable a central computer to calculate the circumference of the circular pattern of the moving pivot arm over time; (4) GPS coordinate readings over time to enable a central computer to calculate the azimuth of the current position of the GPS receiver mounted at or near the end of the pivot arm with reference to the fixed center point calculated in 2, above (i.e., the current pivot position stated in degrees of a circle with north being 0 degrees); (5) GPS coordinate readings over time to enable a central computer to calculate the center pivot ground speed overtime; (6) GPS coordinate readings over time to enable a central computer to calculate the rate of water application (using the ground speed calculated in 5, above); and (7) GPS coordinate readings over time to enable a central computer to calculate the direction of movement of the pivot arm (clockwise or counter-clockwise).

It is a further object of the present invention to provide a wireless interface remote monitoring system that can be used with both center pivot irrigation systems and lateral (linear) move systems, including hydraulically-driven pivot and lateral move sprinklers.

It is a further object of the present invention to remotely sense water delivery to an outer pipe span of the center pivot by means of a sensor incorporated into the wireless interface remote monitoring system (RTU) that detects the presence of water delivery using water pressure or water flow and to send such water status data (wet/dry) by long distance telemetry to a central control computer operated by a third party service operator for the benefit of respective pivot operators anywhere.

It is a further object of the present invention to upload the information processed by the central control computer to discrete website pages for respective end users, the content of which will include graphic and tabular data displays of pivot running status (color-coded circular graphics indicating pivot and water delivery status with a line or marker indicating current pivot arm position in degrees from north, direction of travel, speed of travel, and water application rate, field by field, both historical and in real time).

It is a further object of the present invention to provide a universal, self-contained, wireless interface remote monitoring system that is economical to manufacture; simple to install and relocate; efficient in use; capable of being retrofit to any of a number of different center pivot irrigation systems without modification; reliable; and well suited to operate on both center pivots and linear move systems in all environments, anywhere in the world.

To accomplish these and other objects, a wireless interface RTU designed to retrofit on any mechanized irrigation system is provided with a self-contained power source, an accelerometer requiring no hard-wired connections to detect running or stopped center pivot sprinkler status, a GPS receiver requiring no hard-wired connections to redundantly detect running or stopped center pivot sprinkler status, a method of sensing water delivery, a processor, and a telemetry radio transceiver (terrestrial or satellite).

An alternative and redundant method of the present invention for detecting the movement or non-movement of a center pivot is through a series of timed GPS coordinate readings taken by the GPS receiver built into the RTU. If the pivot has stopped moving, these GPS readings would all be within the defined error tolerance for a stationary object. If the pivot arm were continuing to move, these time-phased coordinate readings would fall outside of the GPS error tolerance, thereby indicating movement. By this means, the GPS receiver data would be interpreted to determine movement or non-movement and, by use of several readings over a span of time, determine the pivot speed and direction of travel. This GPS method of monitoring movement or non-movement of the pivot arm is particularly well suited to the monitoring of the on/off status of hydraulic-powered pivot and lateral move irrigation systems whose drive towers move at a constant rate, which is not easily detected by an accelerometer.

A water delivery sensor connected to the sprinkler pipe is used to simultaneously monitor and record the delivery of water (minimum pressure in or flow through the pipe approximate to the drive tower being monitored with the accelerometer and with the GPS receiver). Based on a change in status or on a timed basis, data packets of center pivot sprinkler running or stopped status (determined by the accelerometer and the optional GPS coordinate measurement algorithms), GPS coordinate data and water delivery status can be transmitted over wireless telemetry systems to a central control computer to remotely determine pivot movement or non-movement and wet or dry status over a span of time.

The RTU mounted at an outer pipe span of the center pivot communicates by radio (terrestrial or satellite) to a central control computer that is internet connected. The data packets are, in one embodiment, event-driven whenever the RTU determines that a pivot has changed from stopped to moving or from moving to stopped or whenever the RTU determines that a pivot has changed from a “wet” to a “dry” or a “dry” to a “wet” water delivery status. In addition, the data packet will include time stamps for all recorded status conditions, including the current GPS coordinates indicating pivot arm position. All status changes and other data packet reports can be processed at the central server using appropriate software and data can be detailed and summarized for the benefit of each irrigator. The data can be prepared for presentation via the internet. The internet content can be uploaded to discrete pages of a website(s) for use by pivot managers and operators and others and can include summary and detail displays of wet or dry status, running or stopped pivot status, speed of travel, direction of travel, rate of water application and pivot arm position for individual pivots and for groups of pivots.

Additionally, the status data collected by the central control computer can be delivered to center pivot managers and operators and others over mobile telemetry platforms, including any internet-connected communication device, alphanumeric paging systems, text messaging services and over other portable wireless devices available to mobile center pivot operators that are capable of receiving e-mail, SNTP, SMTP, FTP or other wireless messaging.

Additionally, the status data collected by the central control computer can be delivered verbally to center pivot managers and operators and others using interactive voice response (IVR) or other conventional voice messaging techniques and device.

These and other advantages, features, and objects of the present invention will be more readily understood in view of the following detailed description and the drawings.

### BRIEF DESCRIPTION OF THE DRAWINGS

The present invention will become more clearly appreciated as the disclosure of the invention is made with reference to the accompanying drawings. In the drawings:

FIG. 1 is a pictorial diagram showing a center pivot irrigation system having a remote terminal unit (RTU) according to the present invention positioned near an outer drive tower of a pivot span with an accelerometer and a GPS receiver and showing the telemetry path for the status data sent to a ground station and forwarded to a central control computer for processing and redelivery to a pivot operator.

FIG. 2 is a diagram illustrating movement of a pivot irrigation system and GPS coordinate readings being used to plot such movement over time.

FIG. 3 is a diagram illustrating one method of calculating the center point and the azimuth of a center pivot sprinkler using three GPS position coordinate readings.

FIG. 4 is a flow chart of the main processing steps used by the RTU to remotely monitor and log status changes to a central control computer.

FIG. 5 is a flow chart of the main processing steps used by the GPS receiver equipped RTU to remotely monitor and log status changes to a central control computer.

FIGS. 6 and 7 are illustrations showing status change detection and approximation of pivot position over time using GPS data.

FIG. 8 is a pictorial diagram and FIG. 9 is a block diagram showing the wireless interface RTU with an accelerometer and GPS receiver, a center pivot tower control box and a water pressure sensor to detect water delivery—all mounted on the water delivery pipe span near an outer drive tower of a center pivot irrigation system.

FIG. 10 is a pictorial diagram of a data packet with data fields of the present invention.

FIGS. 11 and 12 are pictorial diagrams of aerial maps of the irrigation site showing the historic path of the moving sprinkler and current deviation which can trigger malfunction alerts.

### DETAILED DESCRIPTION OF THE INVENTION

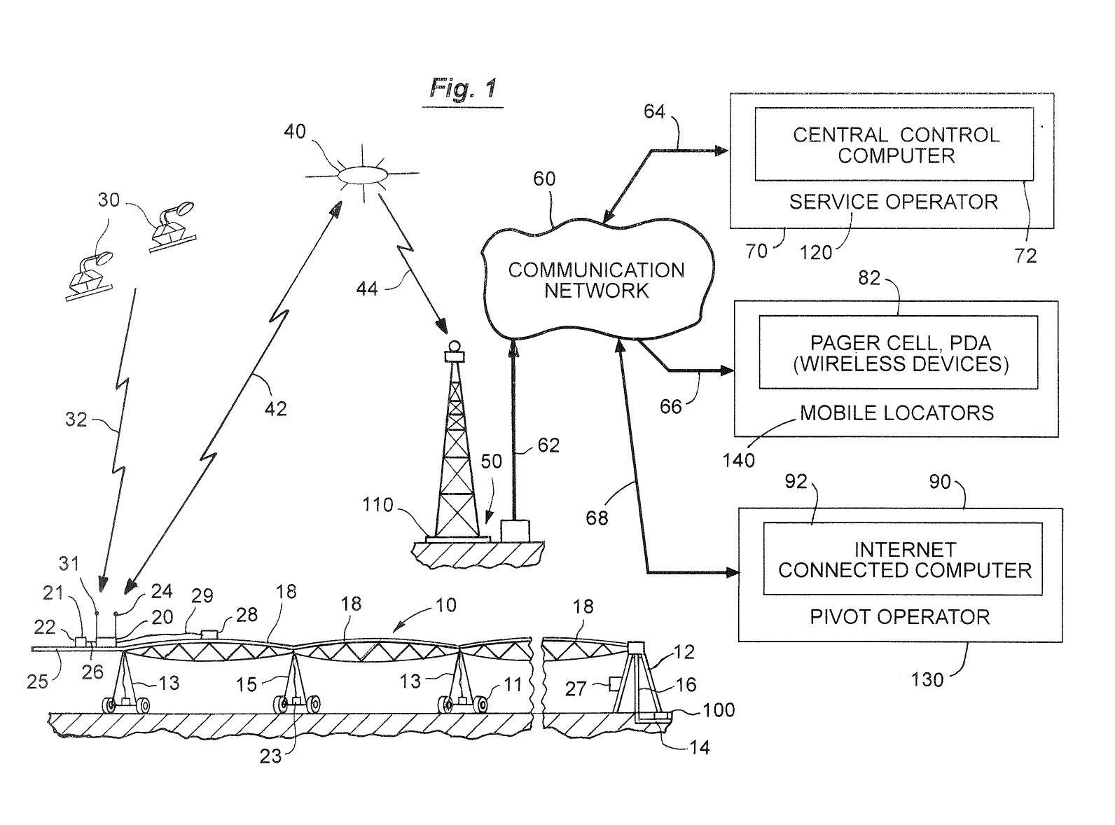

The system of the present invention is illustrated in FIG. 1 as being connected to a center pivot or lateral mechanized irrigation system 10 (herein sometimes simply referred to as “pivot” or “center pivot”). The invention includes a universal, self-contained remote terminal unit (RTU) 20 with an accelerometer 21 that measure acceleration of the RTU along three axes, and an optional global positioning satellite (GPS) receiver 31 that receives signals 32 from GPS positioning satellites 30. Optionally, the accelerometer 21 can also be employed to sense vibrations transmitted through the steel structure of the pivot tower caused by a running electrical or hydraulic motor 23 and drive train associated with rotating the wheel assemblies 11 that move the wheeled drive towers 13 supporting the respective pipe spans 18. The remote terminal unit is further in communications 42 with a low orbit data communication satellite 40, a ground station 50, a communication network 60, a service operator location 120, multiple mobile locations 140, and a remote pivot operator monitoring location 130.

Mechanized irrigation systems 10 are conventional and commercially available from a number of different manufacturers. Mechanized irrigation systems 10 are commonly used in a center pivot configuration such as shown in FIG. 1 wherein the center pivot point 12 extracts pressurized water 14 for delivery through a fluid delivery system 16 through spans of pipe 18 supported by wheeled drive towers 13 for delivery onto the ground. Such center pivot irrigation systems 10 have wheels 11 at pivot drive towers 13 and the center pivot pipe spans 18 can add up to any desired length from center pivot point 12 to pivot end position 25. Another type of mechanized irrigation system not shown is one that moves in a lateral or linear orientation across a field. The present invention is not limited to the type of mechanized irrigation system (center pivot 10 or lateral move, not shown). The center pivot system 10 shown in FIG. 1 is used for purposes of illustrating and explaining the present invention. The center pivot irrigation system 10 is located at a first physical location 100.

The self-contained RTU 20 with GPS receiver 31 and an accelerometer 21 of the present invention is typically located on any outer drive tower 15 of the center pivot irrigation system 10. The term “self-contained” means that the RTU 20 does not hard-wire interface to the electronics or the electrical wiring of the control or power circuitry for the mechanized irrigation system 10. It provides a self-contained operation independent of and isolated from the electrical circuitry of the mechanized irrigation system 10.

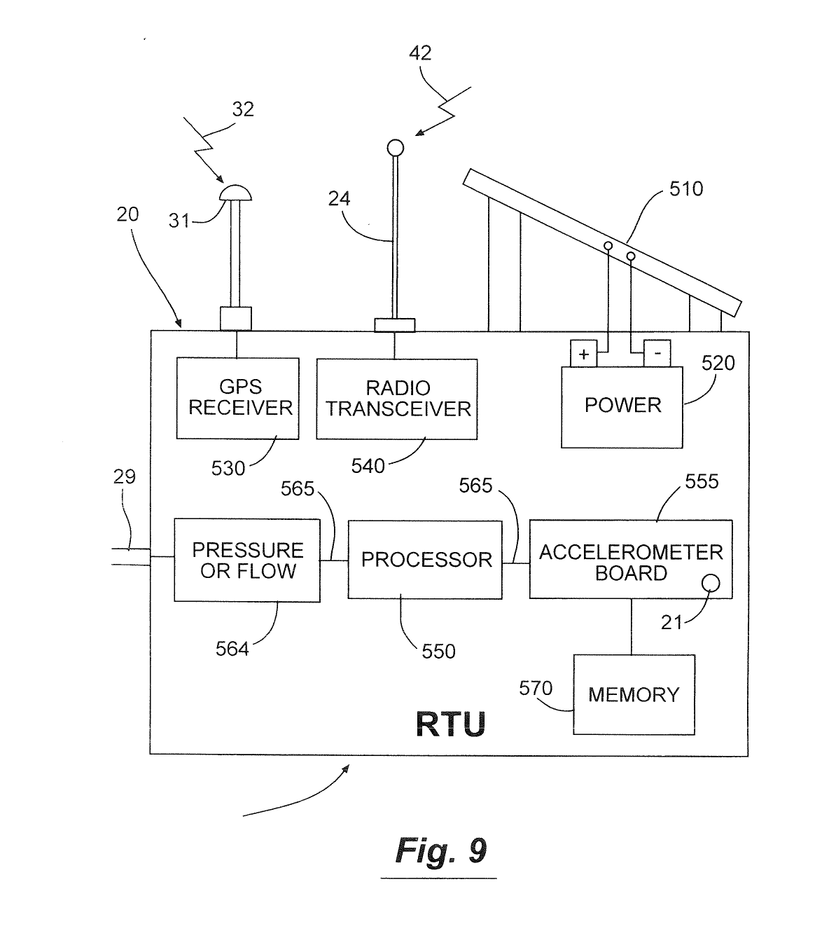

The details of the RTU 20 and the accelerometer 21 of the present invention will be presented subsequently in FIGS. 8 and 9. However, the RTU 20 has a satellite or terrestrial communication antenna 24 and a GPS receiver and antenna 31. The RTU 20 of the present invention has a wireless interface (i.e., no hard-wire connections are used) with the center pivot irrigation system 10 using an accelerometer 21 mounted inside the RTU enclosure (on either a separate circuit board 555 or the RTU processor 550) typically located near the tower control box 22. The accelerometer 21 is used for detecting movement and/or vibration caused by the drive motor 23 and therefore movement of the drive tower 15 over time. In other words, the RTU 20 is mounted to a point along the roving or moving pipe span 18 of the center pivot 10, but does not hard-wire interface with any of the tower control box 22 wiring 580 used to control or power the drive motors 23 of center pivot irrigation system 10.

Conceptually, the accelerometer 21 behaves as a damped mass on a spring. When the accelerometer 21 experiences acceleration, the mass is displaced to the point that the spring is able to accelerate the mass at the same rate as the casing. The displacement is then measured to give the acceleration. In commercial devices, piezoelectric, piezo-resistive and capacitive components are commonly used to convert the mechanical motion into an electrical signal. Piezoelectric accelerometers rely on piezo-ceramics (e.g., lead zirconate titanate) or single crystals (e.g., quartz, tourmaline). They are unmatched in terms of their upper frequency range, low packaged weight and high temperature range. Piezo-resistive accelerometers are preferred in high-shock applications. Capacitive accelerometers typically use a silicon micro-machined sensing element. Their performance is superior in the low frequency range and they can be operated in servo mode to achieve high stability and linearity.

Modern accelerometers are often small micro electro-mechanical systems (MEMS), and are indeed the simplest MEMS devices possible, consisting of little more than a cantilever beam with a proof mass (also known as seismic mass). Damping results from the residual gas sealed in the device. As long as the Q-factor is not too low, damping does not result in a lower sensitivity.

Under the influence of external accelerations, the proof mass deflects from its neutral position. This deflection is measured in an analog or digital manner. Most commonly, the capacitance between a set of fixed beams and a set of beams attached to the proof mass is measured. This method is simple, reliable, and inexpensive.

Most micromechanical accelerometers operate in-plane, that is, they are designed to be sensitive only to a direction in the plane of the die. By integrating two devices perpendicularly on a single die a two-axis accelerometer can be made. By adding an additional out-of-plane device three axes can be measured. Such a combination may have much lower misalignment error than three discrete models combined after packaging.

Typically, center pivots and lateral move sprinklers use a one-minute timer to cycle the drive motor 23 of the outer tower 15 on and off. The speed setting is a percentage of the one minute cycle time used by an electromechanical or solid state timer incorporated into the control circuitry of the pivot main panel 27. Using a control circuit wire running from the main panel 27 (center point) to a control box mounted at the last tower 13 of the pivot, the speed timer device controls an electrical contactor in the outer-most tower box that in turn cycles the last AC drive motor on and off. As an example, assume a center pivot speed timer device is set to run a 20% speed. The last tower 13 is powered on for twelve seconds (20% of 60 seconds) and then is left off for the remaining forty-eight seconds of the one-minute cycle. This results in acceleration of the drive tower 13 of the outer pivot span 18 from a stopped status to a full speed, running status once during each elapsed one-minute of time. This provides a rhythmic cycle of movement readily detected by an accelerometer 21. Such detected movement over time can provide a movement signature in the form of acceleration from stopped to moving. The drive-train mechanics of typical pivots result in approximately a 1:2000 gear reduction between the AC drive motor (1,750 RPM at 60 cycles) and the final drive wheel gear box (1.14 RPM). Therefore, pivots accelerate rapidly from stopped to a top speed of about 10 to 20 feet per minute when drive motors 23 are running. The tower ground speed varies with slight changes in gearing, with various wheel/tire diameters and with varying field conditions causing wheel slippage. When a drive tower AC motor 23 is cycled off, a deceleration movement from running to stopped results in a similar, but slower deceleration movement due to slight coasting of the drive line mechanics from the momentum of the pivot span 18. This deceleration provides a second movement signature slightly different from the acceleration signature.

It should be noted that the last tower of a pivot running at 100% speed would not cycle on and off each minute. Rather, the last tower would run continuously at a constant speed (ten to twenty feet per minute). For a given center pivot, the speed of travel of any running tower is generally the same. Therefore, any inner tower (e.g., next-to-last tower) would necessarily be cycled on and off since the circumference of the path of travel of such towers is a shorter distance than that of the last tower. Alignment of the inner towers is, therefore, maintained by cycling respective inner towers on and off to maintain alignment of all towers so as to not outrun the last tower which may be operating at 100% speed. The signature movement of a next-to-last tower is not necessarily as rhythmic as a last tower running slower than 100%, but it does create a signature of movement due to the on/off cycle necessitated by the alignment system of the pivot. Such on/off cycling is readily detected by the accelerometer means of detecting movement. Thus, mounting the RTU with an accelerometer at a next-to-last tower would provide adequate movement signatures, even when the outer-most tower is running constantly (100%).

The accelerometer 21 is also capable of detecting small vibrations, such as those transmitted into the tower structure 13 by the motor 23, gear boxes and drive shafts making up the drive line transmitting torque to the drive wheels. These vibrations are typically present whenever a drive motor 23 is running. The vibration signature sensed by the accelerometer 21 provides a second means for determining the running status of a last pivot tower 13 or next-to-last pivot tower 15. This approach would not be affected by span movement related to wind.

A second, redundant and slightly slower method of determining pivot movement or non-movement is by way of a GPS receiver 31 and antenna, receiving GPS satellite 30 signals by wireless path 32. The processor 550 in the RTU 20 records a time-series of GPS position coordinates in non-volatile memory in the RTU 20. GPS position readings over time are used by the processor 550 (FIG. 9) in the RTU 20 to determine movement or non-movement of the drive tower 15. These GPS coordinate readings also provide data to determine the drive tower 15 speed and, thereby, movement of the pivot arm 18.

The low-orbit communication satellite 40 is also a conventionally available service such as Orbcomm or Iridium, either of which is in communication with antenna 24 for delivery of data packets as shown by wireless path 42. Orbcomm is located at 21700 Atlantic Boulevard, Dulles, Va. Orbcomm U.S. Pat. No. 6,594,706 is incorporated herein by reference. Iridium Communications, Inc. is located in McLean, Va. The main patents on the Iridium system, U.S. Pat. Nos. 5,410,728 and 5,604,920, are in the field of satellite communications, and the manufacturer generated several hundred patents protecting the technology in the system. All are incorporated herein by reference. The low-orbit satellite 40 is also in communication by wireless path 44 with a ground station 50 at a remote second location 110. It is well known that such ground stations 50 can receive the data packets transmitted from a remote device such as the RTU 20 over an antenna 24 to the satellite 40 for delivery into a communication network 60, such as by means of a communication line 62. While the use of a low-orbit satellite telemetry system is one approach, the present invention is not limited to this and it is to be understood that any suitable satellite or terrestrial telemetry transmitter (receiver) system can be utilized for collecting data from the RTU 20 for delivery into a communication network 60.

The communication networks 60 are existing and well known and include private communication networks for communication over the internet. Any suitable communication network 60 can be used for purposes of the present invention.

A service operator 70 at another remote location 120 retrieves the data by way of communication path 64 from the communication network 60 and processes it for a responsible person or pivot operator 90 (end-user). The service operator 70 at location 120 has a central control computer 72 which processes the received data from the RTU 20, on behalf of a center pivot operator 90, for the delivery of the data by path 66 to multiple mobile locations 140 in a format that can be received and displayed by wireless devices 82 such as pagers, cellular phones using text messaging or by internet connectivity to computers 92, PDAs, iPads and other handheld PCs, etc. Examples of the format of such wireless messages can include email, SNTP, SMTP, FTP, text messages, graphical displays, website content, etc., that can be received by remote mobile devices 82 carried by mobile pivot operators 90 and others. The service operator can deliver more detailed monitoring information received from communication network 60, through path 64 and processed by central control computer 72. This processed information can be delivered by communication path 68 to the center pivot operator's 90 computer 92 at the location 130. As an example, the service operator 70 could determine roving pivot arm 18 position (azimuth), speed and direction of travel, calculate area of the circle covered by the center pivot, cumulative water application in acre-inches to the entire circle or to a pie-shaped segment of the circular field based on hours of pumping (wet time), water application rate at current speed and the acres irrigated and provide this information in summary and detail form to the pivot operator 90 at location 130 on an internet connected computer 92.

In FIG. 1, the present invention provides the pivot operator 90 responsible for monitoring the operation of the pivot irrigation system 10 at location 100 with the ability at location 130 or at the mobile locations 140 to monitor the status of the drive tower 15 by means of RTU 20 and an accelerometer 21 and a GPS receiver 31, so as to know when the center pivot irrigation system 10 is moving or when it is not moving (movement provided by wheeled drive towers 13). Other parameters such as pivot position (azimuth); speed and direction of travel are calculated by the processor 550 in the RTU 20 from the accelerometer 21 data and from the GPS data received from GPS satellites 30 over wireless path 32. Also, the pivot operator 90 at locations 130 and 140 can monitor water pressure and/or flow rate and cumulative flow as indicated by pressure/flow sensor 28 over hydraulic water line 29 to RTU 20.

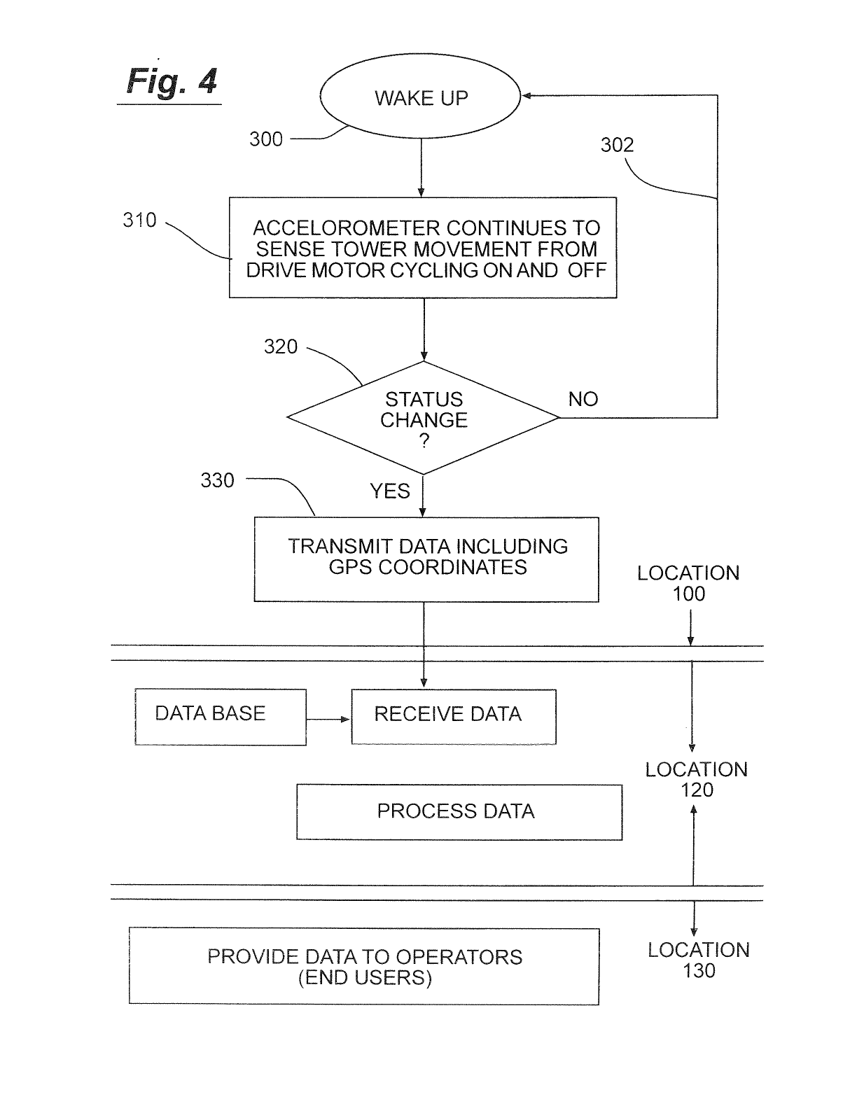

In FIG. 4, the accelerometer method of the present invention is set forth. The RTU 20 wakes up in step 300. An internal clock or timer in the processor 550 causes the RTU 20 to power-up at predetermined intervals, such as every minute. This wake-up feature is conventional and conserves the power supply 520 (FIG. 9) within the RTU 20. The RTU 20 at location 100 then receives 310 the status of the accelerometer 21 (running or stopped). In step 320, the method of the present invention determines whether a status change has occurred. For example, the prior status could have been “no movement” (no motion or motor-caused vibration detected by the accelerometer over a set period of time). If the accelerometer data 310 currently being delivered indicates “movement” over a set period of time, a status change 320 has occurred. Or, the prior status could have been “movement”. In which case, if the accelerometer data 310 currently being delivered indicates no movement, then a status change 320 of “no movement” has occurred. In FIG. 4, the transmit data step 330 is event driven, so that whenever the RTU 20 determines that a pivot 10 has changed from a stopped to moving status or from a moving to stopped status over a set period of time, or whenever the RTU 20 determines that a center pivot 10 has changed from a wet to a dry water delivery status as indicated by sensor 28 and hydraulic water line 29, the status data is sent via a data packet using a wireless path 42 to the communication satellite(s) 40. The data packet includes stored data of center pivot sprinkler 10 running status, current GPS position coordinates and water delivery status data so as to establish a wet or dry, running or stopped status to be delivered to the service operator 70 at location 120.

For the accelerometer 21 for monitoring movement as illustrated in FIG. 4, a number of different mathematical algorithms can be used to determine when a status event occurs in stage 310 that requires a status change in 320. The mathematical algorithm used depends on the signature created by the accelerometer 21 from sensing movement of the center pivot tower 15 or vibration originating from the motor 23. Wind can cause motion to be detected, but the motion or movement created by the drive wheels 11 and vibration created by the motor 23 can both be unique in comparison to the movement or motion caused by wind loads on the pivot structure 10. Whatever mathematical algorithm is used to determine movement or non-movement of drive tower 15, the processor 550 using stored accelerometer 21 readings in memory 570 determines a status change event from either “movement” to “non-movement” or from “non-movement” to “movement.”

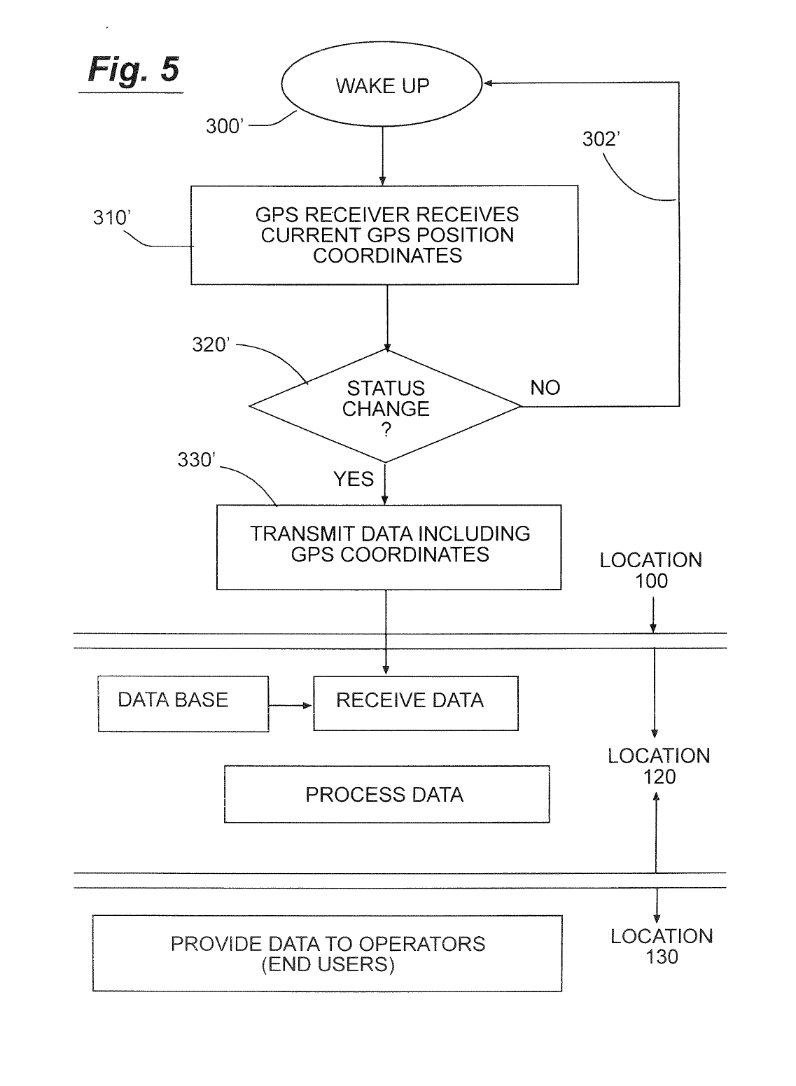

In FIG. 5, the GPS method of the present invention is set forth. This is a redundant, but slightly slower method to the accelerometer method of determining movement or non-movement set forth above in FIG. 4. The GPS system of the present invention provides a series of GPS coordinate data readings received at the RTU 20 from GPS satellite(s) 30 over wireless path 32 and transmitted by wireless path 42 to communication satellite 40 to ground station 50 and on to the central control computer server 72 by means of communication network 60 to enable the central control computer server 72 to calculate pivot arm 18 position (azimuth), speed of travel, direction of travel and rate of water application.

Referring to FIG. 5, the RTU 20 wakes up 300′. In this step, an internal clock or timer causes the RTU 20 to power-up at predetermined intervals such as every minute. This wake-up feature is conventional and conserves the battery power supply 520 within the RTU 20. An alternative method of controlling wake-up is to only wake-up when the accelerometer detects movement based on the movement signature recognized by the accelerometer. Once powered up, the RTU 20 at location 100 receives 310′ the current GPS position coordinates. Processor 550 compares these current GPS position coordinate readings to a prior GPS position coordinate reading 310′ to determine a status change (from movement to non-movement or non-movement to movement of drive tower 15). The GPS coordinate readings that are compared over time are interpreted within known GPS error tolerances by processor 550 in RTU 20 to determine a position change that is interpreted to be movement or non-movement. In step 320′, the method of the present invention determines whether a status change has occurred. If the RTU 20 determines a change in status from moving to stopped or from stopped to moving has occurred 320′, then the changed status causes RTU 20 to transmit 330′ a data packet with current GPS position coordinates to the central control computer 72. For example, if the prior status determination was “no movement” and the current GPS position coordinate readings indicate a new position (prior and current GPS position coordinates when compared result in a new position outside the error tolerance of the GPS system), then a change in status 320′ has occurred and a data packet is transmitted 330′. If, on the other hand, the prior status determination was “no movement” and the current GPS position coordinate readings indicate the same position (prior and current GPS position coordinates when compared result in the same position within the error tolerance of the GPS system), then a no change in status 320′ has occurred and no data packet is transmitted by 330′.

In FIG. 5 the transmit data step 330′ is event driven, so that whenever the RTU 20 determines that a pivot 10 has changed from a stopped to moving status or from a moving to stopped status, or whenever the RTU 20 determines that a pivot 10 has changed from a wet to a dry water delivery status as indicated by sensor 28 and hydraulic water line 29, the status data is sent by way of a data packet using wireless path 42 to the communication satellite(s) 40. The data packet includes stored data of center pivot sprinkler 10 running status, current GPS position coordinates and water delivery status data so as to establish a wet or dry, running or stopped status to be delivered to the service operator 70 at location 120.

For the GPS method of monitoring movement as illustrated in FIG. 5, a number of different mathematical algorithms can be used to determine when a status event occurs in step 310′ that requires a status change in 320′. The mathematical algorithm used depends upon the error tolerance assumed for the GPS position coordinate readings and the time interval between readings. If an intermediate drive tower 13 nearer to the center pivot point 12 is being monitored and the speed control of the last drive tower is set to a low percent speed setting at main panel 27 (e.g., six seconds on and 54 seconds off to the outermost drive motor), then the tolerance for determining a non-movement status would be relatively long as compared to monitoring vibration or movement caused by the motor 23 moving the last drive tower 13 or the next-to-last drive tower 15 of a center pivot sprinkler 10. Whatever mathematical algorithm is used to determine movement or non-movement of a drive tower 15, the processor 550 using stored GPS position coordinate readings in non-volatile memory 570 determines a status change event from either “movement” to “non-movement” or from “non-movement” to “movement.”

It is to be expressly understood that in one embodiment, all raw data even at close time intervals of one minute could be delivered to the service operator 70 at location 120 for processing by central control computer server 72 according to the methods of FIGS. 4 and 5 or that discussed immediately above. Indeed, in another embodiment all such processing could occur in the processor 550 in the RTU 20 or even at computer 92 at location 130.

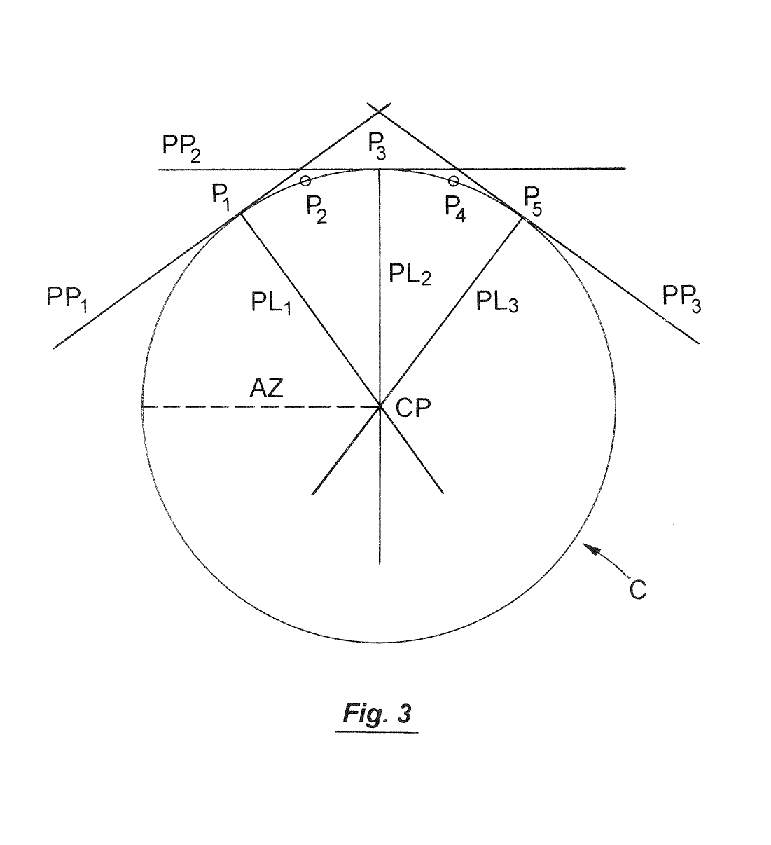

FIG. 3 is an illustration of the present invention wherein the central control computer server 72 plots the pattern of sequential GPS position coordinates p1-p5. The sequential GPS position coordinates can be a combination of events (FIGS. 4 and 5, step 330) and timed self-reports from RTU 20. Assuming that roving pivot arm 18 is continuing to move, the points p1-p5 make up a portion (i.e., a pie-shaped segment) or the entire circumference of the circle formed by the path of the roving center pivot arm 18 at an outer point 25. Using three or more points from p1-p5 along the arc making up the partial circumference C, three respective tangential lines PP₁, PP₂ and PP₃ are plotted. From the point of intersection of lines PP₁, PP₂ and PP₃ with the arc C of circular path (any of p1-p5.about.), three perpendicular lines PL₁, PL₂ and PL₃ are drawn. The point where lines PL₁, PL₂ and PL₃ intersect is the theoretical center point CP of the circular path C made by the roving pivot arm 18 at outer location point 25. Any straight line from center point CP to the present location on the circumference C of the circle p1-p5 is the azimuth AZ. The length of the azimuth AZ is the radius of the circle and represents the roving pivot arm 18 location 25 at a point along path p1-p5. Once the center point CP is determined, any single GPS real time position coordinates received from RTU 20 at central control computer 72 can be used to calculate the azimuth AZ for the roving pivot arm 18. The calculation described above as being performed by the central control computer 72 could also be performed in the RTU 20 by the processor 550.

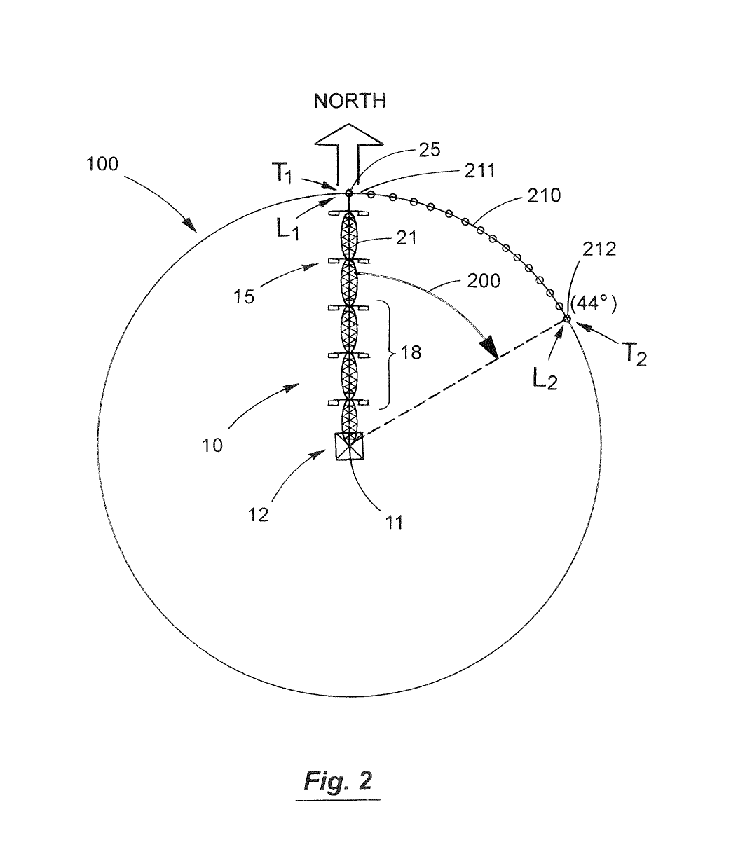

In FIG. 2, an overhead view of location 100 is shown with the pivot irrigation system 10 moving in the direction of arrow 200. The movement 200 is typically slow such as one hundred feet per hour. Hence, in ten hours the movement 200 can be over a distance 210 such as one thousand feet, which is shown by time T₂. In other words, the movement 200 from time T₁ to time T₂ is ten hours' worth of movement at one hundred feet per hour or one thousand feet. T₁ is a time reference and T₂ is a second time reference ten hours later. Hence, if the pivot irrigation system 10 were properly operating, the person at the monitor location 130 would expect that at time T₂ the pivot would be at location L₂ having moved from location L₁ at time T₁. In this example of ten hours from T₁ to T₂, the satellite ground station 50 in communication with the RTU 20 has typically taken a number of readings at a frequency such as one every ten to fifteen minutes as illustrated by the dotted line on the circumference of travel 210. Assuming one every ten minutes, or six readings per hour then in ten hours, sixty readings are taken between time T₁ and time T₂.

All GPS position coordinate readings taken at RTU 20 and transmitted to central control computer 72 are time encoded. These GPS position coordinate readings with time stamp T₁-T2 about the circumference combined with the theoretical coordinates for center point coordinates CP are also used by software at the central server to calculate the theoretical azimuth AZ of the pivot arm 18, ground speed, direction of travel, and using the wet dry sensor and fixed water delivery rate the rate of water application by acre. As will be explained, in another embodiment, not every reading is transmitted to satellite 40.

Referring to FIG. 2, with ground speed of an outer point 15 (location of RTU 20) of the center pivot arm 18 of irrigation system 10 at one hundred feet per hour, and with a location L reading every ten minutes, the movement between adjacent readings is only seventeen feet per reading. As this is near the current error tolerance of most conventional WAAS GPS devices, the determination of location L requires more than one reading to occur in the system of the present invention to be assured of movement 200 and how much movement has occurred. Therefore, the primary method and system in the present invention detects the presence of movement (i.e., whether the pivot irrigation system 10 is moving or not) using the accelerometer 21. However, the GPS receiver 31 can also be used as a redundant back-up to determine movement or non-movement over time as well as to determine the azimuth AZ of the pivot arm 18 from the center pivot point 12, the direction of movement 200 (i.e., clockwise or counterclockwise) and the ground speed of the outer end of the pivot arm 25. The GPS method for determining running or stopped status of a center pivot 10 is significant because it provides a unique way of monitoring the status of a hydraulically-powered center pivot or lateral move sprinkler. The accelerometer 21 requires motion caused by power to the drive wheels turning on and off in a detectable rhythm (signature) or from vibration transmitted to the tower structure 15. Hydraulic pivots do not use AC current for drive or control power and do not turn on and off to control the speed of the drive tower 13. Rather, they continuously move at a steady ground speed using hydraulic line pressure connected to hydraulic-drive motors. The hydraulic line pressure is varied by adjusting the in-line valves for wheel drive power. In operation, each drive tower of a hydraulically-powered pivot moves at a constant speed that maintains pivot arm 10 alignment without the on/off cycle commonly used by electrically-powered pivots.

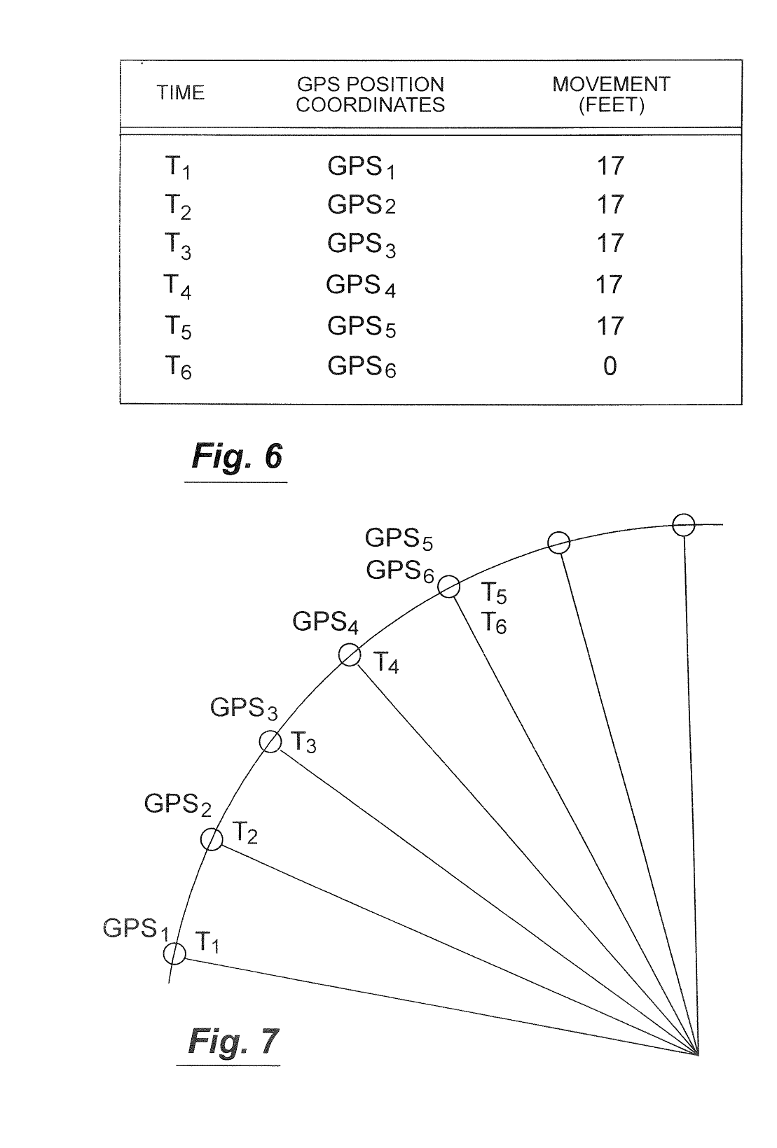

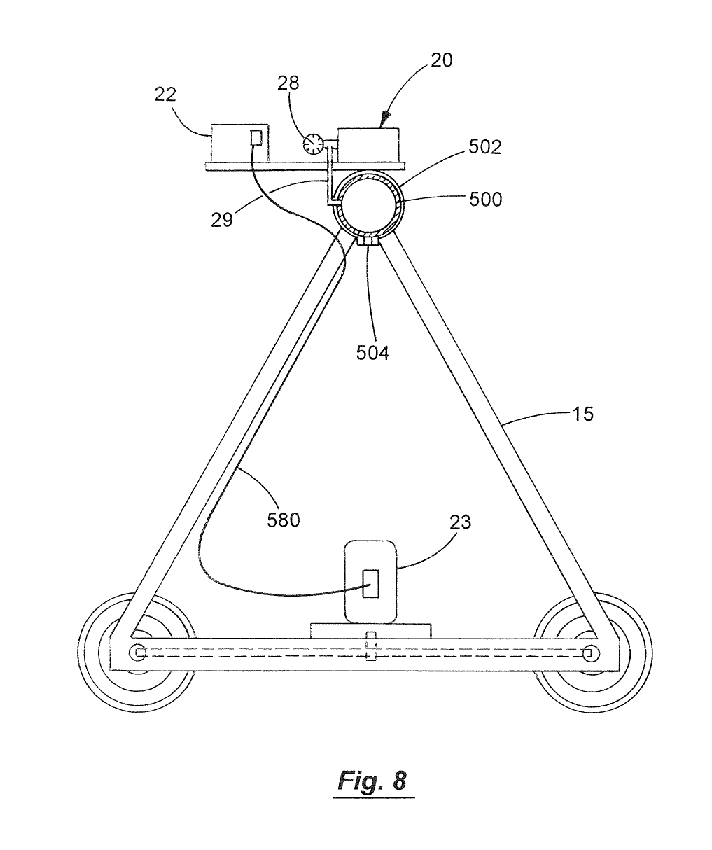

The detection of the status change event in step 320 of FIG. 4 and step 320′ in FIG. 5 are two embodiments of the present invention. In another embodiment, the time readings (self-reports from RTU 20) T₁-T₆ (FIG. 6) and time readings T₁-T₆ (FIG. 7) could occur at ninety-minute intervals and steps 320 and 320′ are not used. Each GPS position coordinate reading would then be transmitted 330 and 330′, and any processing with respect to movement or non-movement of the pivot irrigation system 10 would use GPS position coordinates logged over time at the service operator 70 location 120 using the central control computer 72.

FIG. 6 sets forth a table showing GPS coordinate readings (GPS₁-GPS₆) corresponding to times (T₁-T₆). Assume the RTU 20 takes readings every ten minutes based on signature motion or movement detected by the accelerometer 21 and further assume that the ground speed is one hundred feet per hour. It is expected that if the end tower 15 of the center pivot irrigation system 10 is moving it should move about seventeen feet every reading. Due to the tolerance error in the GPS readings, the seventeen feet reading is small enough to be near the tolerance error. Therefore, several sequential GPS position coordinate readings are required. The processor 550 (see FIG. 9) calculates the fixed center pivot point 12 (CP) and determines the azimuth AZ of the roving pivot arm 18 for each GPS reading, the linear distance between recorded time-stamped GPS coordinates stored in memory 570 and further calculates direction of travel and ground speed.

With reference back to FIG. 5, in step 310′ the RTU 20 receives readings at times T₁-T₆. The processor 550 in the RTU 20, over several readings, then processes the GPS readings. For example as shown in FIG. 7, assume the pivot irrigation system 10 is moving (i.e., the status is “moving”) prior to T₁ in arc 400, the GPS₁ reading at time T₁ is compared with several prior readings and movement is verified so no status change occurs in stage 320′. At time T₂ the GPS₂ reading is compared to several prior readings and movement is again verified. Likewise, the RTU 20 reaches the same conclusion at reading time T₃, GPS₃. And, at time T₄, GPS₄ again, movement is verified. At time T₄, GPS₄, in one embodiment, the processor 550 can look at the prior four GPS readings (i.e., over forty minutes) to verify that movement of about sixty-eight feet has occurred. Prior GPS readings with time stamps are stored in memory 570. This distance is outside the error tolerance of the GPS readings and verifies that movement of the outer point 25 (FIG. 1) is ongoing so there is no status change occurring in step 320′.

In other words, at four discrete times T₁-T₄, loop 302′ occurs in FIG. 5. Assume at time T₅, GPS₆ the processor 550 in the RTU 20 with respect to that one reading senses no movement, but since this one reading is within the error tolerance of the GPS system when compared to the prior three readings (T₄, T₃ and T₂), the RTU 20 determines movement has occurred and thus no status change in 320′. However, with respect to reading at time T₆, GPS₆ when compared to readings at T₅, T₄ and T₃, in forty minutes only thirty four feet in movement has been detected, the RTU 20 in step 320′ concludes a status change of “no movement” has occurred based on readings at T₃, T₄, T₅, and T₆ and step 330′ is entered. It is to be expressly understood that more or less than four readings could be utilized and more or less than ten minutes could be utilized depending upon the design configuration. A number of different mathematical algorithms can be used to determine when a status event occurs in step 310′ that requires a status change in 320′. The mathematical algorithm used depends upon the tolerance for error of the GPS receiver, the time interval, and the ground speed.

The above calculations can also include confidence and sequence factors. For example, with respect to confidence, if the accelerometer 21 indicates no movement of the outer pivot point 25 over several minutes then there is high confidence that the pivot 10 is off. If the accelerometer 21 indicates movement of the outer pivot point 25 (pivot on) the degree of confidence can be altered by using GPS readings over time. If the status, based on the accelerometer 21 data were moving (possible false positive from wind motion), then a high confidence of no movement would be five successive readings within the tolerance error. A lower confidence would be three successive readings. With respect to sequence, if in the above example at time T₆, GPS₆, a noticeable seventeen-foot change is observed, the sequence of events at times T₄ and T₅ in one embodiment of the algorithm, may be ignored. Whatever mathematical algorithm is used, the processor 550 using stored GPS readings in memory 570 determines a status change event from either “movement” to “non-movement” or from “non-movement” to “movement.”

Furthermore, the detection of the status change in step 320 of FIG. 5 is one embodiment of the present invention. In another embodiment, the time readings T₁-T₆ and GPS₁-GPS₆ could occur at thirty-minute intervals and step 320′ is not used. Each reading would then be transmitted 330′, and any processing with respect to movement or non-movement of the pivot irrigation system 10 would occur at the service operator server 70 location 120. Again, the time interval of thirty minutes is subject to design configuration, status of accelerometer data and GPS accuracy considerations.

It is to be expressly understood that in one embodiment, all raw accelerometer 21 data and GPS data even at close time intervals of ten minutes could be delivered to the service operator server 70 for processing according to the method of FIG. 5 or that discussed immediately above. Indeed, in another embodiment all such processing could occur at the subscriber monitor 90 location 130.

In FIGS. 8 and 9, the RTU 20 is shown mounted to a pipe 500 at drive tower 15 of the pivot irrigation system 10. The RTU 20 is mounted by means of a strap 502 and is securely affixed thereto by means of bracket clamps 504 engaging the strap 502. The RTU 20 is mounted in a horizontal position and has a solar panel 510 mounted on the top of the RTU 20 to receive sunlight to charge a battery within the power supply 520 within the RTU 20. The GPS antenna 31 is interconnected to a GPS receiver 530, the satellite data receiver antenna 24 is connected to a satellite transmitter 540 and the RTU 20 contains a processor 550. Also shown in FIG. 8 is a water pressure switch and gauge 28 (optional) with water hydraulic line 29 connected to the pipe 500 to sense the water pressure inside the pipe and a corresponding transducer 564 for converting the analog water pressure to an electrical or digital signal. The processor 550 is in communication 565 with the pressure switch or pressure transducer device 564. An accelerometer 21 is mounted to a small circuit board 555. The accelerometer board 555 detects the presence of a signature movement or absence of a signature movement related to the acceleration force or motor vibrations detected by the accelerometer 21.

It is to be expressly understood that other components can be found in the RTU 20 and that the RTU 20 has an encapsulated housing which is environmentally sealed to protect its contents from external elements. The transmitter 540 is a satellite or terrestrial radio transmitter and receiver. The processor 550 is programmed with suitable firmware/software to operate with respect to the discussion above with respect to the flow charts of FIGS. 4 and 5. The processor 550 is connected to a non-volatile memory 570.

As shown in FIG. 3, what is delivered to the subscriber at the subscriber's location 130 or at a mobile location could be a graphic display. The graphic display could be overlaid with a topological map of the field, a satellite view of the field, or an aerial photographic view of the field. This provides important information to the subscriber as the subscriber may be aware of certain topological or soil conditions with respect to the field at the present detected location of the roving pivot arm 18 of pivot irrigation system 10.

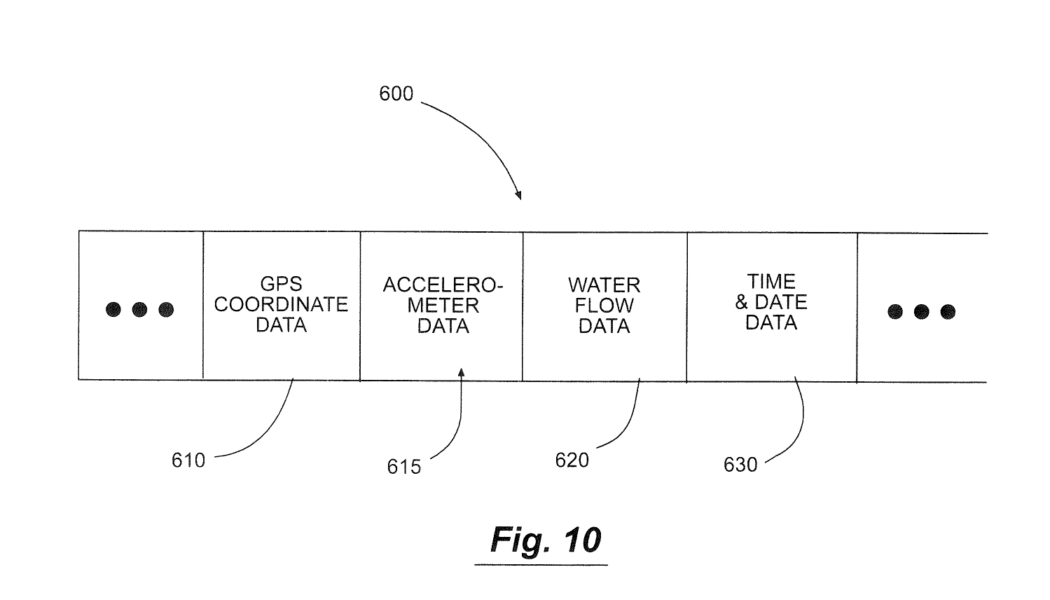

In FIG. 10, a data packet 600 that is transmitted from antenna 24 over wireless link 42 to satellite 40 and then to ground station 50 is shown. The data packet 600 contains a field 610 containing the GPS coordinates, a field 615 containing the accelerometer data status, a field 620 containing the water flow information and a field 630 for the time and date stamp. It is expressly understood that the arrangement of these data fields is based on design choice, and that other information could be present in additional fields in the data packet 600.

With respect to collecting water pressure and/or flow information from pressure switch 28 and transducer 564, the processor 550 at the time intervals T stores readings with a time stamp in memory 570. Unlike the GPS readings, the water pressure/flow readings do not have a high tolerance error and in one embodiment of the present invention, whenever a water pressure/flow reading changes by a certain percentage of the pressure range monitored, processor 550 enters step 320 or 320′ and transmits the event to ground station 50. The pressure switch 28 and transducer 564 in FIG. 9 can be set to a digital input high or digital input low so as to operate as an on/off switch. In this embodiment, rather than that discussed previously, the processor 550 does not take individual pressure readings. Rather, a pressure threshold for wet and dry status can be set for each individual pivot situation.

At other predetermined time intervals such as every twenty-four hours, the processor 550 sends a “heartbeat” data packet to the ground station 50 and then to the service operator 120 simply to verify normal operation of the RTU 20. Heartbeat data packet transmissions are conventional. The heartbeat data packet includes the same information such as the accelerometer data indicating movement or non-movement status of the monitored outer tower, the GPS coordinates (time stamped) and the wet/dry water delivery status. The GPS coordinates are conventional latitude and longitudinal coordinates and can also be used to determine movement or non-movement status of hydraulic powered center pivot or lateral move sprinklers.

As fully discussed above, the RTU 20 of the present invention is located at or near the end tower 15 of the center pivot 10 and is a self-contained, universal RTU that will work with any of a number of conventional pivot or lateral move irrigation systems 10 from a wide variety of manufacturers. The term “self-contained” means that the RTU 20 does not interface to the electronics or the wiring of the control or power circuitry for the mechanized irrigation system 10. It provides a self-contained operation independent of and isolated from the electrical circuitry of the mechanized irrigation system 10. The RTU 20 does not interface with any control electronics of the pivot irrigation system 10. It is, therefore, easily installed and easily relocated to different center pivots to maximize monitoring benefits as to other irrigation systems. The RTU 20 is located in a position to provide ample sunlight to its solar panel 510 and to allow antennas 24 and 31 to optimally operate without encountering any adverse effects from the operation of the pivot irrigation system 10 such as water spray.

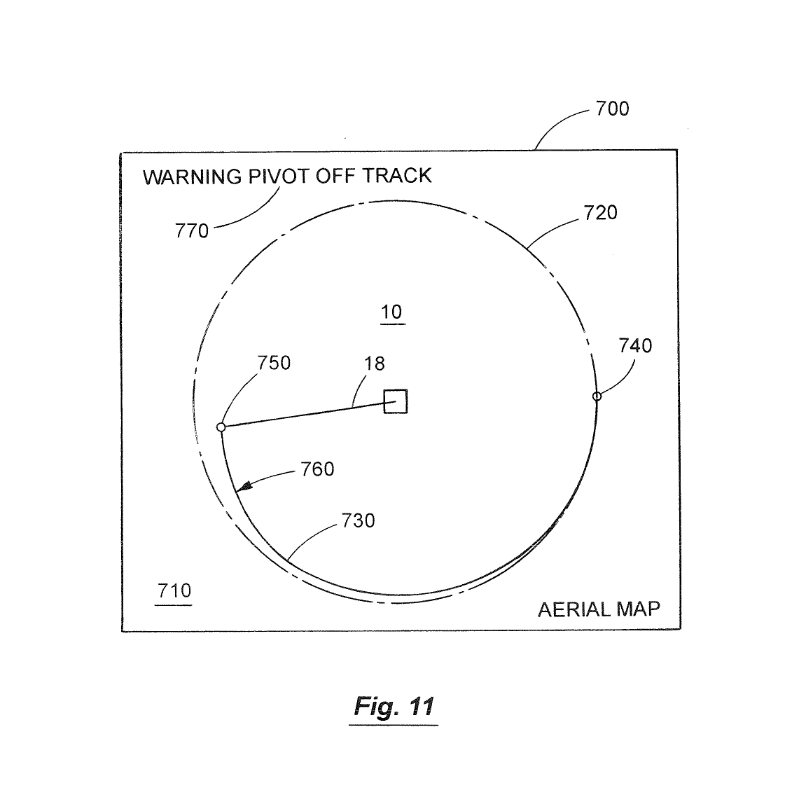

In FIG. 11, a display 700, in one embodiment, is provided to the subscriber in the mobile device 80 and/or the computer 92 at location 130. In FIG. 11, the display 700 has the aerial map 710 displayed for a pivot 10. A geographic information system (GIS) source for map data could also be used. With each full rotation of the pivot irrigation system 10, the service operator 70 provides an expected path 720 (shown in dotted lines). In other words, the service operator software in control computer 72 learns from prior rotations as to what is the expected rotation 720. In another embodiment, rather than having an expected rotation based upon a number of prior rotations, the path 720 could simply be the last path of rotation. What is provided to the subscriber either in mobile device 80 or in computer 92 at location 130 is path 720 (based upon historic travel or the immediately prior travel). The current path 730 (shown in solid line) is also displayed having a start position 740 and a current position 750. With the pivot 10 normally operating the current travel path 730 will overlay path 720. When the current position 750 comes full circle back to start 740, path 730 starts all over again. Or, in another embodiment, the point 740 could be continually moving such as always trailing 180° from the current position 750 (or any suitable trailing angle).

This provides important information to the irrigator. For example as shown in FIG. 11, a deviation 760 is occurring. This could be mechanical failure in that the end drive tower 13 of the pivot irrigation system 10 is moving out of the normally expected ground track for the end wheels 11, which could be caused by the pivot irrigation system 10 jack-knifing (collapsing inward toward the center pivot point) somewhere along its roving line 18.

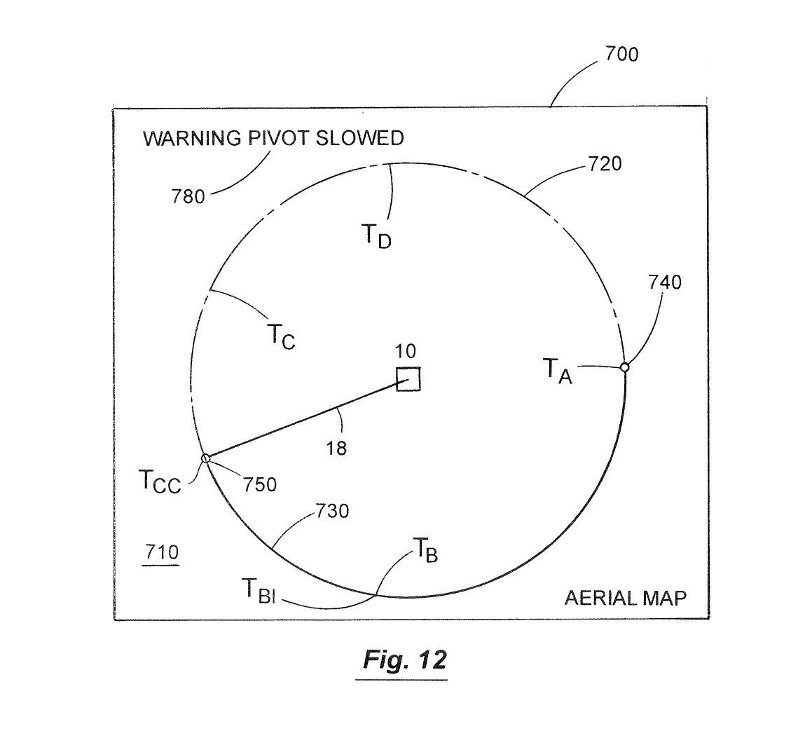

In another aspect of the present invention shown in FIG. 12, the service operator 70 in its control computer 72 analyzes the data received and provides the same information as found in FIG. 11. However, in addition, based upon a prior number of historic full complete paths 720 of the pivot irrigation system 10, the central control computer 72 software determines expected times for arrival of the end tower 13 of the pivot as it travels the full circular path 720. In FIG. 12, these historic times are labeled T_{A}-T_{B}. Any suitable number of historic times around the historic path 720 can be established by software in the central control computer 72. In FIG. 12, the current travel path 730 is on track at current time T_{BC} that corresponds to time T_{B}. However, end 15 carrying the RTU 20 of the present invention does not arrive at the historic expected time of T_{C}. As shown in FIG. 12, the current time T_{CC} for the end of the pivot 10 is at location 750 (based upon GPS coordinates). A malfunction has obviously occurred with the pivot 10 such as a flat tire on the outer tower that slows down the pivot movement, wheel slippage or other drive mechanism failures. The subscriber can immediately visit the pivot irrigation system 10, site 100 to effectuate repairs. It is to be understood that in this situation of FIG. 12, the pivot irrigation system is still moving and so a “status event” had not been detected by either the accelerometer 21 or by the GPS receiver 31 in FIGS. 4 and 5, respectfully.

In FIGS. 11 and 12, suitable warning messages 770 or 780 could be utilized such as audible indicators, graphic indicators, text messages, alerts, email messages, paging messages, etc.

It is understood that while a self-contained RTU 20 has been shown and described, it is also possible to locate the elements, such as the solar array 510 and antennas 24 and 31 remotely from the unit and they can be connected to the RTU 20 by suitable cables and connectors.

It is to be understood that the central control computer 72 can utilize the received data over path 64 concerning the status of the mechanized irrigation system 10 to perform various calculations. Through the use of the data the central control computer 72 can calculate the theoretical center point 12 of the arc or circle plotted by a series of GPS data points recorded over time. In addition the central data processor can calculate the theoretical azimuth between the center point 12 of the arc or circle covered by the sprinkler and the position of the roving RTU as defined by the GPS position coordinate data received in the most current data packets from the RTU. The central control computer 72 further calculates the area of the circle covered by the irrigation system 10 using the azimuth as the radius and can currently determine the angular position of the azimuth from north that identifies the position of the roving pivot arm 18. The central control computer 72 can use the theoretical azimuth as the radius of a full circle covered by the center pivot sprinkler 10 to calculate the area of the irrigated circle. It can also use the GPS data points and two respective azimuths to define a pie shaped area of the irrigated circle. Thus, the respective irrigated section of the circular field is determined using the time stamp sequential GPS position data points and each respective azimuth to calculate the area. By using the water delivery rate from the irrigation system and the elapsed time between two data points, the area in acres of a section (pie-shaped segment) defined by the two data points can be used to calculate the acre-inches of water applied to the designated area.

The central control processing computer 72 can also calculate the water application in acre-inches resulting from the rotation speed of the center pivot 10 calculated and by applying variables of water pumping rate, acreage irrigated and water application efficiency assumptions. In addition, the central control computer 72 can calculate the time to complete a full circle by the irrigator. Along with these calculations the central control processing computer can determine expected time for arrival of the roving pivot arm to reach various predetermined positions in the irrigated field. It is further understood that the RTU self-reports data packets of pivot 10 status and GPS coordinates on a periodic position points such as every 30 degrees, or on a timed basis such as every twelve hours.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A universal remote terminal unit for use in a pivot irrigation system wherein a control circuit controls movement of the pivot irrigation system, the universal remote terminal unit comprising:
a self-contained housing mounted to an outer moving portion of a pivot irrigation system, being independent of and not interfacing with the control circuit;
an accelerometer mounted within the housing, sensing acceleration of the outer moving portion of pivot irrigation system, and generating output data signals indicative of said acceleration;
a processor within the housing and receiving the output signal data from the accelerometer, said processor processing the output data signals to determine whether the pivot irrigation system is moving and preparing status data indicative of a movement change; and
telemetry within the housing and connected to said processor, said telemetry sending the status data from the processor over a wireless communication path to alert an operator of an operational change in the movement of the irrigation system.

2. The universal remote terminal unit of claim 1 further comprising:
a global positioning satellite receiver mounted within the self-contained housing generating output data signals indicative of the location coordinates of the universal remote terminal unit which over a series of timed readings is indicative of the movement of the pivot irrigation system;
and wherein the processor is connected to receive said output signals from said global positioning satellite receiver, said processor processing the output data signals to determine whether the pivot irrigation system is moving as a redundant check on movement of the pivot arm.

3. The universal remote terminal unit of claim 2 wherein the accelerometer output data is analyzed by the processor to determine the need to power the GPS receiver as a redundant check on movement of the pivot arm, thereby conserving power when no movement is detected by the accelerometer.

4. The universal remote terminal unit of claim 1 wherein the housing is mounted to an outer wheel drive tower of the pivot irrigation system whose movement is indicative of the operation of the irrigation system.

5. A method of monitoring field movement of a pivot irrigation system independently of a control circuit located on the pivot irrigation system, the control circuit controlling field movement of the pivot irrigation system, the method comprising the steps of:
sensing movement of the pivot irrigation system by means of an accelerometer located in a self-contained unit independent of and not interfacing with the control circuit on an outer moving portion of the pivot irrigation system;
determining operational data based on the accelerometer movement data in a processor located in the self-contained unit when movement of the pivot irrigation system changes;
delivering the operational data from the self-contained unit to a communications network and into a service computer remotely located from said pivot irrigation system;
generating in the remote service computer at least one type of information message on movement change based on the delivered operational data; and
receiving the generated information message on movement change in at least one mobile operator device.

6. The method of claim 5 further comprising the step of placing the self-contained unit on a pipe span above an outer drive tower of the pivot irrigation system.

7. The method of claim 5 further comprising the step of determining at least one operational parameter for the information message on movement change from the operational data in the processor located in the self-contained unit.

8. The method of claim 5 further comprising the step of determining at least one operational parameter for the information message on movement change from the operational data in the remote service computer.

9. The method of claim 5 wherein the information message on movement change contains information as to the speed of the moving pivot irrigation system.

10. The method of claim 5 wherein the information message on movement change contains information as to the direction of movement of the pivot irrigation system.

11. The method of claim 5 further comprising:
generating GPS coordinate data at predetermined time intervals in a global positioning system receiver located in the self-contained unit; and
determining the operational data based on a combination of accelerometer movement data and the generated GPS coordinate data in the processor located in the self-contained unit.

12. The method of claim 11 further comprising the steps of:
comparing, in the processor in the self-contained unit, accelerometer data in combination with the GPS coordinate data during a current predetermined time interval with prior accelerometer data and the GPS coordinate data obtained during at least one prior predetermined interval;
delivering the current accelerometer data and the GPS coordinate data as the operational data from the self-contained unit to the communications network when the current accelerometer data and the GPS coordinate data has changed from the prior accelerometer data and the GPS coordinate data in response to the step of comparing; and
determining, in the service computer, movement status of the pivot irrigation system from the delivered accelerometer data in combination with the GPS coordinate data in the operational data.

13. The method of claim 11 further comprising the steps of:
comparing, in the processor in the self-contained unit, accelerometer data in combination with the GPS coordinate data during a current predetermined time interval with prior accelerometer data and the GPS coordinate data obtained during at least one prior predetermined interval;
determining, in the processor in the self-contained unit, the movement status of the pivot irrigation system when the current accelerometer data in combination with the GPS coordinate data has changed from the prior accelerometer data and the GPS coordinate data in response to the step of comparing; and
delivering movement status in the operational data from the self-contained unit to the communications network.

14. The method of claim 5 wherein the step of delivering further comprises delivering the operational data from the self-contained unit to a communications satellite in communication with the communications network.

15. The method of claim 5 wherein the step of delivering further comprises delivering the operational data from the self-contained unit to terrestrial telemetry in communication with the communications network.
